(19) United States
(12) Patent Application Publication
(10) Pub. No.: US 2009/0132926 A1
(43) Pub. Date: May 21, 2009

(54) INTERACTIVE PRESENTATION SYSTEM AND AUTHORIZATION METHOD FOR VOICE COMMAND CONTROLLING INTERACTIVE PRESENTATION PROCESS

(75) Inventor: Victor V. BUCHA, Moscow (RU)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/274,634

(22) Filed: Nov. 20, 2008

(30) Foreign Application Priority Data
Nov. 21, 2007 (RU) 2007142859
Aug. 22, 2008 (KR) 10-2008-0082367

(51) Int. Cl. G06F 3/00; G10L 11/00

(52) U.S. Cl. 715/730; 704/275; 704/E15.001

(57) ABSTRACT

Provided is an interactive video presentation system including a screen, a presentation computer, a video image projector and a microphone for recording voice commands, and a radiating device which forms a signal on the projection screen. The radiating device displays, on the projection screen, an image chosen by a user from a set of images preinstalled in the radiating device. Authorization of the voice commands, which are used in the interactive video presentation system, is performed by processing a received voice command in parallel with processing a confirming signal.

### CROSS-REFERENCE TO RELATED PATENT APPLICATIONS

This application claims priority from Russian Patent Application No. 2007142859 filed on Nov. 21, 2007 in the Russian Intellectual Property Office and Korean Patent Application No. 10-2008-0082367 filed on Aug. 22, 2008 in the Korean Intellectual Property Office, the disclosure of which is incorporated herein in its entirety by reference.

### BACKGROUND OF THE INVENTION

1. Field of the Invention

Apparatuses and methods consistent with the present invention relate to a video presentation system, and to methods allowing a user to interact with a presentation system by using an emitting device such as a laser pointer and a device for recording and analyzing speech.

2. Description of the Related Art

At present, a computer presentation system is usually controlled by means of active computer input devices, such as a mouse, a light pen, a trackball or a keyboard. However, when a lecturer has to draw the attention of an audience to a computer display, such devices are not convenient to use in the presentation process and a control device or an assistant is needed to handle the presentation process. Also, remote control devices for the presentation, which transfer operating signals by means of infrared or radio connections, can be used. However, such devices require the enhanced attention of the speaker and interaction with a projector or a computer by using of the remote control device.

Also, interactive presentation systems, which operate by using laser pointer type devices, are available. These systems operate by projecting a laser beam on a presentation screen, so as to form a light signal in certain area of the presentation screen. A position of a projecting laser spot and its other characteristics (color and movement, etc.) are fixed by a video camera and processed in a control module for recognizing characteristics of the projected laser spot. These characteristics are used to change a cursor position of a computer or execute certain commands, for example, a transition to a next slide.

Presentation control systems operated by voice commands are available. The voice commands are recognized in the control device and transformed to corresponding commands. However, another person or speaker can casually or purposefully give a voice command and the presentation control system may inadvertently react to the command. Therefore it is necessary to provide natural and convenient methods to control a computer presentation system, which would combine the computer presentation system with cursor control of a computer and execution of the voice commands authorized by the speaker, thus controlling a presentation process.

A common problem of conventional methods to control a presentation process is that they do not provide a user with convenience in terms of controlling a computer cursor and executing presentation commands. Although the voice command can be possibly considered as the most natural method to control a presentation process, the conventional presentation system should select a voice command of a speaker from among surrounding acoustic noise, such as retorts and questions of an audience. As devices for identifying a voice are complex and expensive, other technical tools, which provide execution of actions required by an interactive video presentation system in a combination with a voice command, are more often used.

### SUMMARY OF THE INVENTION

The present invention provides an interactive presentation system and authorization method of voice commands. Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention provides an interactive presentation system and authorization method of voice commands, which allow a speaker to concentrate on performance and provides convenient methods of interaction with and control of the presentation system.

The present invention provides a method of voice commands used in an interactive video presentation system, which would allow a lecturer to authorize performance of a maximum number of operations using demonstrative video images with a minimum loss of attention.

According to an aspect of the present invention, there is provided an interactive video presentation system, the system including: a projection screen; a presentation computer comprising a video image projector and a microphone to record a voice command; and a radiating device which forms a light signal on the projection screen, wherein the radiating device displays, on the projection screen, an image chosen by a user from a set of images preinstalled in the radiating device.

The system may further comprise a video camera which captures an image formed on the projection screen; a control device which recognizes the image projected by the radiating device and the voice command recorded by the microphone; and a computer command generation module which forms an execution command and transfers the execution command to the presentation computer for modification of the projected image

The control device may recognize a pause as a voice command.

The presentation computer, the control device, the video camera, the projector and the microphone may be implemented in the form of a combined stand-alone device. According to another aspect of the present invention, the presentation computer may be separate and distinct from the image projector.

The control device, the video camera and the microphone may be implemented as a combined stand-alone device structure.

According to another aspect of the present invention, there is provided a method of authorizing a voice command used in an interactive video presentation system, the method comprising: processing a received voice command in parallel with processing a confirmation signal, wherein a projection of an image from among a pre-established set of images onto a presentation screen is used as the confirmation signal, and each of the pre-established set of images is associated with one of voice commands included in a pre-established set of commands.

### BRIEF DESCRIPTION OF THE DRAWINGS

The above and other features and advantages of the present invention will become more apparent by describing in detail exemplary embodiments thereof with reference to the attached drawings in which:

FIG. 1 shows a presentation system according to an exemplary embodiment of the present invention.

FIG. 2 displays a set of light images, projected by a laser pointer and recognized by a laser device according to an exemplary embodiment of the present invention.

### DETAILED DESCRIPTION OF ILLUSTRATIVE, NON-LIMITING EMBODIMENTS OF THE INVENTION

The present invention will now be described more fully with reference to the accompanying drawings, in which exemplary embodiments of the invention are shown.

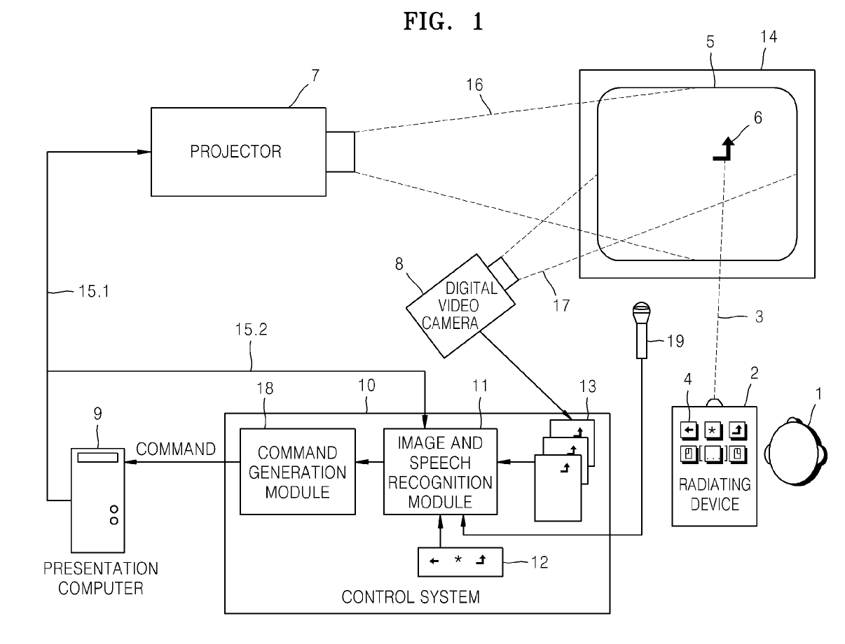

FIG. 1 shows an interactive presentation system according to an exemplary embodiment of the present invention.

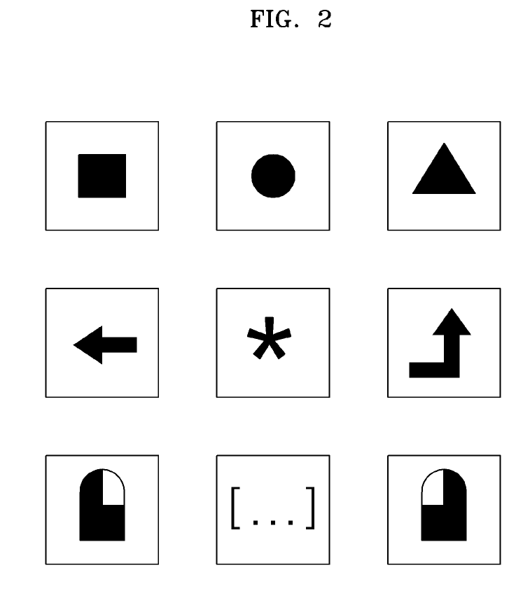

FIG. 2 displays a set of light images projected by a laser pointer and recognized by a control device according to an exemplary embodiment of the present invention.

Referring to FIG. 1, the interactive presentation system includes a radiating device 2 (for example, a laser pointer) which is used to display light images having different forms, a presentation computer 9 which generates presentation images, a projector 7 which is connected to the presentation computer 9 and displays images on a presentation screen 14, a digital video camera 8, a microphone 19 and a control system 10 using coded images (FIG. 2) and voice commands for subsequent recognition.

During a presentation, the presentation computer 9 generates a video stream 15.1 consisting of presentation images. The video stream 15.1 is transformed to a light stream 16. The light stream 16 is projected on the presentation screen 14 causing a presentation image 5 to be formed. One ordinarily skilled in the art would recognize that although a light stream is projected onto a presentation screen, any device or method that would allow the display of an image on a screen will suffice.

A speaker (lecturer) 1 interactively controls the interactive presentation system by displaying images on the presentation screen 14 by using the radiating device 2 (FIG. 2). The radiating device 2 has function keys 4. By pressing one of function keys 4, a corresponding image, which is projected on the presentation screen 14 by using a laser beam 3, is chosen. One ordinarily skilled in the art would recognize that although a radiating device projecting a laser beam onto the presentation screen is described here, other devices which display an image on a screen may be used.

Each projected image is associated with a certain execution command. Therefore the speaker 1 may press a corresponding function key to authorize the execution command. The association of an execution command with a projected image is fixed and pre-programmed, or is assigned by the user during installation and adjustment of the presentation system.

Both a projected image 6 and the presentation image 5 form a common image 17, which is recorded by the digital video camera 8. The sequence of the recorded image 13 is transferred to a control system 10. An initial presentation image for displaying 15.2 is also input to the control system 10. Also, the control system 10 previously contains coded images 12 which are identical to the images projected using the radiating device 2. The control system 10 includes an image and speech recognition module 11. The image and speech recognition module 11 compares the initial presentation image 15.2 and/or the coded images 12 with an image captured by the digital video camera 8 and carries out a search for the projected image 6 and its location. Then, the searched for (recognized) image is converted to a computer command or to authorization of a voice command by using a command generation module 18 according to the association of the recognized image and a computer command. The generated computer command is transferred to a presentation computer and is used to modify the presentation image. For confirmation of execution of the generated computer command, it is possible to use a corresponding voice command. Also, the corresponding voice command may be a pause of the speaker, for example. Although a digital video camera has been described here as a common device for screen sensing, one ordinarily skilled in the art would recognize that other screen sensing devices may be used to fulfill the same purpose.

The image and speech recognition module 11 is also responsible for recognizing the voice commands, which are recorded using the microphone 19. To execute the recognized speech command, it is necessary to receive a confirmation light signal in the form of a certain image projected on the presentation screen. One ordinarily skilled in the art would recognize that although a microphone is described here, other effective devices for recognizing a voice command may be used.

The interactive presentation systems and methods described herein may be used for noise proof control of a computer presentation and electronic board. The above methods and systems can be used, instead of active devices such as a mouse and a keyboard, to control computer cursors, to choose and execute computer commands, or to input text information.

In other words, for prevention of unauthorized performance of a voice command it is proposed to use an image projected by means of a laser pointer or another radiating device on the projective screen. This image is recognized by a control system 10 and compared to a standard. When a voice command is given, it is transformed to a computer command and the computer command is executed. On the other hand, it may be required to provide control of the computer cursor to perform selection operations in relation to text, objects, etc. A natural method of such an interaction of the user with the presentation system is to use a laser pointer to display a laser spot/image on the presentation screen and its location is defined by a control system 10. The laser pointer is used for movement/modification of the computer cursor and the projected image.

The user operates the interactive presentation system using the radiating device 2 and voice commands. A laser pointer is capable of projecting a laser spot of the various forms onto the presentation screen. The projected image is chosen by pressing corresponding buttons located on the radiating device. The quantity of buttons, their location and projected images of the present invention are not limited. Although a laser pointer is described here, one ordinarily skilled in the art would recognize that any device which performs a similar function may be used.

The projected image on the presentation screen and the presentation image are recorded using one or several video recording devices. Video recording devices are placed either in front of the screen, or behind it. A recorded video sequence is transferred to the control system 10 and the control system 10 processes the recorded video sequence in real time mode. Also, digital audio is transferred to the control system 10 which contains presentation images and voice commands of the speaker. Audio information is recorded by using a microphone 19 and transforming the analog audio signals to a digital format by using an analog-digital converter (ADC).

An operating process of the presentation system will now be described. During presentation, the presentation images are generated using the presentation computer 9, which are projected on the presentation screen by using a projector 7. At the same moment, the speaker can project a light image 6 on the presentation screen 14 by using a radiating device 2 such as a laser pointer. The digital video camera 8 fixes the common image 5 formed on the presentation screen, which consists of the presentation image and a projected laser image. The video sequence received by the digital video camera 8 is analyzed by the control system 10 to find a light image and its location is calculated as coordinates in the presentation image. Each light image is associated with a computer command, such as pressing of a mouse key, selection of a text, drawing of the presentation image, skipping to the next slide, etc. Recognition of a light image is executed by using known image recognizing and processing methods. A recognized image is transformed to a computer command, which is transferred and executed on the presentation computer 9. As a result, the presentation image may be changed according to the speaker's intentions.

Movement of a light image is also tracked by the control system 10 and used for changing the location of the computer cursor. Depending on the chosen mode, the cursor can be used for selection of objects or drawing graphic primitives on the presentation image.

An authorization command of a voice command recorded using the microphone 19 and analyzed by the control system 10, is a very important presentation computer command. If speaker 1 gives a voice command, the voice command is recognized by the control system 10 and is transformed to a computer command for execution on a computer. Furthermore, an absence (pause) of speech or sound may be considered as a voice command.

However, for execution of a corresponding computer command, it is necessary to receive additional confirmation in the form of a corresponding image projecting on the presentation screen of a laser. This confirmation can be received directly before, during or directly after a voice command is given.

Also, the voice command or a pause of the speaker can be used for authorization of the computer command generated by the projected image.

The method described above considerably lowers a probability of non-authorized control of presentation system. The probability of erroneous reaction to the keywords contained in voice commands also decreases. The present invention allows a speaker to concentrate on performance and an audience and provides a natural method of interaction with and control of a presentation system.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. An interactive video presentation system comprising:
a projection screen;
a presentation computer comprising a video image projector and a microphone to record a voice command; and
a radiating device which forms a light signal on the projection screen,
wherein the radiating device displays, on the projection screen, an image chosen by a user from a set of images preinstalled in the radiating device.

2. The system of claim 1, wherein the system further comprises:
a video camera which captures an image formed on the projection screen;
a control device which recognizes the image projected by the radiating device and the voice command recorded by the microphone; and
a computer command generation module which forms a computer command and transfers the computer command to the presentation computer for modification of the projected image.

3. The system of claim 1, wherein the control device recognizes a pause as a voice command.

4. The system of claim 1, wherein the presentation computer, the control device, the video camera, the projector and the microphone are implemented in the form of a combined stand-alone device.

5. The system of claim 4, wherein only the control device, the video camera and the microphone are implemented as a combined stand-alone device structure.

6. A method of authorizing a voice command used in an interactive video presentation system, the method comprising:
processing a received voice command in parallel with processing a confirmation light signal,
wherein a projection of a light image from among a pre-established set of images onto a presentation screen is used as the confirmation light signal, and each of the pre-established set of images is associated with one of voice commands included in a pre-established set of commands.

7. An interactive presentation system comprising:
a screen sensing device which captures a command image formed on a screen; and
a control device which recognizes the image formed and outputs an execution command in accordance with the recognized image.

8. The interactive presentation system of claim 7, wherein the system further comprises an audio sensing device which captures a voice command and the control device recognizes the voice command if the recognized image indicates recognizing the voice command, wherein the execution command corresponds to the recognized voice command.

9. The interactive presentation system of claim 8, wherein the screen sensing device recognizes the image one of directly before, during, and directly after the voice command is given.

10. The interactive presentation system of claim 8, wherein the system further comprises a presentation computer and an image projector which outputs a presentation image onto a screen.

11. The interactive presentation system of claim 8, wherein the system further comprises a presentation computer comprising an image projector which outputs a presentation image onto a screen.

12. The interactive presentation system of claim 7, wherein the system further comprises a presentation computer and an image projector which outputs a presentation image onto a screen; and
wherein the control device comprises a command generation module which forms the execution command based on the recognized image and transfers the execution command to the presentation computer for modification of the presentation image.

13. The interactive presentation system of claim 7, wherein the system further comprises a presentation computer comprising an image projector which outputs a presentation image onto a screen; and
wherein the control device comprises a command generation module which forms the execution command based on the recognized image and transfers the execution command to the presentation computer for modification of the presentation image.

14. The interactive presentation system of claim 11, further comprising a command generation module wherein the command generation module forms the execution command based on the recognized voice command and transfers the execution command to the presentation computer for modification of the presentation image.

15. The interactive presentation system of claim 11, wherein the system further comprises a radiating device which generates the image formed on the screen in accordance with a user selection from a set of images preinstalled in the radiating device.

16. The interactive presentation system of claim 11, wherein the control device recognizes a pause as the voice command.

17. The interactive presentation system of claim 11, wherein the control device, the screen sensing device and the audio sensing device are implemented as a combined stand-alone device structure.

18. The interactive presentation system of claim 17, wherein the combined stand-alone device comprises the presentation computer and the projector.

19. A method of authorizing a voice command used in an interactive presentation system, the method comprising: processing a received voice command in parallel with processing a confirmation signal,
wherein an image formed on a screen from among a pre-established set of images is used as the confirmation signal, and each of the pre-established set of images is associated with one of a set of voice commands included in a pre-established set of execution commands.
